(19) United States
(12) Patent Application Publication
(10) Pub. No.: US 2021/0082619 A1
(43) Pub. Date: Mar. 18, 2021

(54) Method for preparing metallic magnetic powder core integrated chip inductor

(71) Applicant: CYGE Electronic Technology (Hunan) Co., Ltd., Loudi (CN)

(72) Inventor: Liliang Su, Loudi (CN)

(73) Assignee: CYGE Electronic Technology (Hunan) Co., Ltd.

(21) Appl. No.: 17/107,631

(22) Filed: Nov. 30, 2020

(30) Foreign Application Priority Data
Oct. 19, 2020 (CN) 202011114582.8

(51) Int. Cl. H01F 41/06; H01F 41/02

(52) U.S. Cl. CPC H01F 41/06; H01F 41/0246

(57) ABSTRACT

A method for preparing a metallic magnetic powder core integrated chip inductor is provided, comprising steps of: winding a hollow spiral coil, compression molding, primary chamfering, hot pressing curing, secondary chamfering, primary nano-insulation coating, primary grinding, electrode copper plating, secondary nano-insulation coating, secondary grinding, electroplating metalized electrode, and testing packaging. The metallic magnetic powder core integrated chip inductor of the present invention adopts nano-insulating material to cover the product body and only retains the bottom electrode for connection, which eliminates tin stacking side area comparing to the paste terminated electroplating type and the material spot welding electrode type integrated chip inductor product, and thus reduce the installation volume of the product on the circuit board, increase the installation density of electronic components on the PCB board.

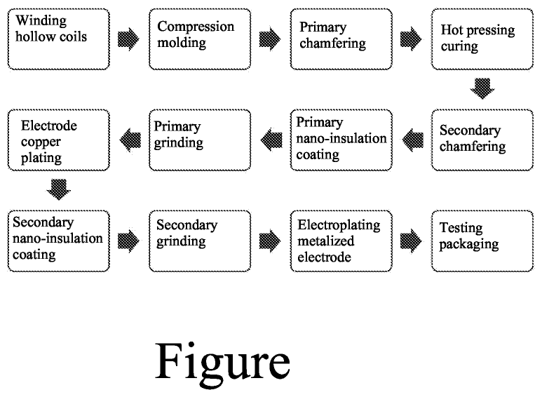

### CROSS REFERENCE OF RELATED APPLICATION

The present application claims priority under 35 U.S.C. 119(a-d) to CN 202011114582.8, filed Oct. 19, 2020.

### BACKGROUND OF THE PRESENT INVENTION

### Field of Invention

The present invention relates to inductor structure, and more particular to a method for preparing a metallic magnetic powder core integrated chip inductor

### Description of Related Arts

The conventional structure of integrated inductors include paste-terminated electroplating type, material spot welding electrode type and T-core electrode type; however , the paste-terminated electroplating type is relatively small in size, when mounted on the chip, the side tin stacking area is large, which reduces the electronic components density on integrated circuits and wastes the space of the circuit board. Meanwhile, the paste-terminated electroplating type has 4 metal layers in the electrode welding area of the body, which are copper/silver/nickel/tin. Parasitic capacitance is easily formed among the 4 metal layers, which increases the DC resistance and reduces the self-resonant frequency when the inductor welded. The lead frame of the material spot welding electrode type one-piece inductor is bent from the side of the product to the bottom. The bending amplitude and the thickness of the frame will make the length of the product longer and limit designing of the coil, leading to a result that the product characteristics is limited, which not only wastes the space of the circuit board but also reduces the density of integrated circuits as well. The productive investment of the T-core electrode type integrated inductor is high and the output is low, thus, the manufacturing cost of the product is very high, which is not conducive to mass production and difficult to rapidly meet the demands of the market.

### SUMMARY OF THE PRESENT INVENTION

An object of the present invention is to provide a metallic magnetic powder core integrated chip inductor that adopts nano-insulating material to cover the product body and only retains the bottom electrode for connection, which eliminates tin stacking side area comparing to the paste terminated electroplating type and the material spot welding electrode type integrated chip inductor product, and thus reduce the installation volume of the product on the circuit board, increase the installation density of electronic components on the PCB board, in such a manner that the overall performance of the product is greatly improved under the same size, and create favorable conditions for the highly integrated development of the integrated circuit industry.

Correspondingly, in order to achieve the object mentioned above, technical solutions provided by the present invention are as follows. A method for preparing a metallic magnetic powder core integrated chip inductor comprises steps of: winding a hollow spiral coil, compression molding, primary chamfering, hot pressing curing, secondary chamfering, primary nano-insulation coating, primary grinding, electrode copper plating, secondary nano-insulation coating, secondary grinding, electroplating metalized electrode, and testing packaging.

Preferably, the step of winding the hollow spiral coil comprises: neatly winding a winding jig with multiple shafts in parallel, ensuring that insulating paint film of an enameled wire is not scratched or crushed, and capable of meeting corresponding parameters.

Preferably, the compression molding comprises putting a hollow spiral coil fixing with a wire winding jig into a mold of the molding machine, then implanting the coil at a setting point in a mold cavity, and injecting micron-level soft magnetic metallic powder into the mold cavity, when the quantified metallic powder completely wraps the hollow spiral coil, tamping and forming; wherein forming density is not less than 3 g/cm³.

Preferably, the one-time chamfering comprises mixing products molded in a certain proportion according to the weight of the product and putting the chamfering mediums into the chamfering equipment to complete a chamfering process.

Preferably, the hot-press curing comprises placing the products neatly into the cavity of the hot-pressing equipment, wherein a temperature of the hot-pressing equipment cavity is not less than 150° C., and the pressure is not less than 0.5 tons, pressure maintaining for not less than 10 minutes to complete the hot pressing.

Preferably, the secondary chamfering comprises mixing the product after thermo-compression and solidification with the chamfering mediums in a certain proportion according to the weight of the product and putting into the chamfering equipment to complete a secondary chamfering process.

Preferably, the primary nano-insulation coating comprises adopting polyimide nano-materials to conduct insulation coating treatment on a surface of the product; wherein a thickness of the insulation layer is not less than Sum; after the product is coated, baking at 150° C. for more than 1 hour to cure the insulation layer.

Preferably, the primary grinding comprises arranging the products neatly into the jig, performing grinding operations on the products by a high-precision grinder; wherein grinding one side of the products with a length of not less than 5 um and exposing both electrode surfaces of the conductive wire copper interface at both ends of the product and the bottom of the products.

Preferably, the electroplating metalized electrode comprises adopting ion plating technology (PVD technology) or conventional electroplating process, adding metal and alloy material coating required on a copper-plated surface to increase weldability, soldering resistance and adhesion of the product.

Preferably, the step of the testing packaging comprises automatically testing and packaging the products to eliminate products with defects in size and characteristics, and packaging the products into carrier tapes.

The beneficial effects of the present invention are as follows.

1). The technical advantage of the present invention is to provide a metallic magnetic powder core integrated chip inductor that only retains the bottom electrode and uses nano-insulating material to cover the product body, which saves tin stacking size of the paste terminated electroplating type and the material spot welding electrode type integrated chip inductor product on a side surface, and thus reduce the installation size of the product on the circuit board, increase the installation space of the PCB board of the integrated circuit, and create favorable conditions for the highly integrated development of the integrated circuit industry; in such a manner that the overall performance of the product is greatly improved under identical size.

2) The manufacturing process adopts ion plating technology or traditional electroplating technology to reduce the plating layer from 4 layers to 2 layers while improving the density of the plating layer, thereby saving manufacturing costs and improving the process yield.

3) Adopting the new nano-insulation coating material and nano-insulation coating technology to make the product insulation coating thickness above 5 um, and the insulation coating material is a thermosetting environmentally friendly polyester imine series material.

These and other objectives, features, and advantages of the present invention will become apparent from the following detailed description, the accompanying drawings, and the appended claims.

### BRIEF DESCRIPTION OF THE DRAWINGS

The FIGURE is a flow chart according to a preferred embodiment of the present invention.

### DETAILED DESCRIPTION OF THE PREFERRED EMBODIMENT

The present invention will be further explained below in conjunction with all the drawings. Referring to the Figure, a preferred embodiment of the present invention is as follows.

A method for preparing a metallic magnetic powder core integrated chip inductor, comprises steps of: winding a hollow spiral coil, compression molding, primary chamfering, hot pressing curing, secondary chamfering, primary nano-insulation coating, primary grinding, electrode copper plating, secondary nano-insulation coating, secondary grinding, electroplating metalized electrode, and testing packaging.

The step (1) of winding the hollow spiral coil comprises: neatly winding a winding jig with multiple shafts in parallel, ensuring that insulating paint film of an enameled wire is not scratched or crushed, and capable of meeting corresponding parameters. Selecting and winding enameled wire have been repeatedly tested, and have obtained winding equipment parameters and wire specification data that can be mass-produced. The winding manner adopts winding multi-axis in parallel on the winding jig, which can increase the winding speed while saving material.

The step (2) of compression molding comprises adopting carbonyl iron powder or alloy materials comprising iron-silicon, iron-silicon-chromium, iron-nickel, iron-silicon-aluminum, amorphous and other material systems, wherein the research and development team has undergone multiple tests, recording data, and selecting the best after statistical analysis. The formula of carbonyl powder ingredients selected are as follows.

Mixing the carbonyl iron powder or alloy material, epoxy resin and acetone by a weight ratio of 100:5:15, and then keeping a temperature at 65° C. for 2 hours, and then crushing and granulating; wherein prepared powder needs to meet the sphericity ≥90%, and the powder particle size to meet: D50≤30 μm, D90≤90 μm, D10≤20 μm; wherein D10 is the particle size at which the cumulative distribution of particles is 10%, that is, the volume content of particles smaller than this size accounts for 10% of all particles; D50 is the particle size at which the cumulative distribution of particles is 50%, also called the median diameter or median particle size, which is a typical value that indicates the particle size; D90 is the particle size at which the cumulative distribution of particles is 90%, i.e. the volume content of particles smaller than the particle size accounts for 90% of all particles; wherein epoxy resin serves as a binder, and zinc stearate is added as a lubricant after the powder granulation is completed;

Putting hollow spiral coil fixing with a winding jig into the mold of the forming machine, then implanting the coil at a setting point in the mold cavity, injecting micron-level soft magnetic metallic powder into the mold cavity, when the quantified metallic metal powder completely wraps the hollow spiral coil, tamping and forming; wherein forming density is not less than 3 g/cm³.

Selection of a specific pressure of the molding machine: If the pressure is too high, paint layer of the spiral coil will be scratched or crushed. If the pressure is too low, density of the product prepared will be insufficient, which causes defects such as missing corners and low inductance of the product. After a large number of experiments, statistical data screen out the optimum parameters that can meet product quality, production efficiency and yield.

The step (3) the primary chamfering comprises mixing molded products in a certain proportion according to the weight of the product and putting the chamfering mediums into the chamfering equipment to complete a chamfering process.

The step (4) the hot-press curing comprises placing the products neatly into the cavity of the hot-pressing equipment, wherein a temperature of the hot-pressing equipment cavity is not less than 150° C., and the pressure is not less than 0.5 tons, pressure maintaining for not less than 10 minutes to complete the hot pressing.

The step (5) the secondary chamfering comprises mixing the product after thermo-compression and solidification with the chamfering medium in a certain proportion according to the weight of the product and putting into the chamfering equipment to complete a secondary chamfering process.

The step (6) the primary nano-insulation coating comprises adopting polyimide nano-materials to conduct insulation coating treatment on a surface of the product; wherein a thickness of the insulation layer is not less than 5 um; after the product is coated, baking at 150° C. for more than 1 hour to cure the insulation layer.

The step (7) the primary grinding comprises: arranging the products neatly into the jig, performing grinding operations on the products by a high-precision grinder; grinding one side of the products with a length of not less than 5 um and exposing both electrode surfaces of the conductive wire copper interface at both ends of the product and the bottom of the products.

The step (8): the copper electroplating: electroplating a copper layer of not less than 10 um on a surface the product after primary grinding.

The step (9): the secondary nano-insulation coating: adoting polyimide-based nano-materials, conducting insulation coating treatment on the surface of the product, wherein a thickness of an insulation layer is not less than 5 um, and after the product is coated, baking at 150° C. for more than 1 hour to cure the insulating layer.

The step (10): the secondary grinding comprising: arranging the products neatly into the jig, performing grinding operations on the products by a high-precision grinder; grinding one side of the products with a length of not less than 5 um and exposing a coating layer of a cooper conductor on a bottom of the product.

The step (11): the electroplating metalized electrode comprises adopting ion plating technology (PVD technology) or conventional electroplating process, adding required metal and alloy material coating on a copper-plated surface to increase weldability, soldering resistance and adhesion of the product.

The step (12): the testing packaging comprises automatically testing and packaging the products to eliminate products with defective sizes and characteristics, and packaging the products into carrier tapes.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for preparing a metallic magnetic powder core integrated chip inductor, comprising steps of: winding a hollow spiral coil, compression molding, primary chamfering, hot pressing curing, secondary chamfering, primary nano-insulation coating, primary grinding, electrode copper plating, secondary nano-insulation coating, secondary grinding, electroplating metalized electrode, and testing packaging.

2. The method for preparing the metallic magnetic powder core integrated chip inductor, as recited in claim 1, wherein the step of winding the hollow spiral coil comprises: neatly winding a winding jig with multiple shafts in parallel, ensuring that insulating paint film of an enameled wire is not scratched or crushed, and capable of meeting corresponding parameters.

3. The method for preparing the metallic magnetic powder core integrated chip inductor, as recited in claim 1, wherein the compression molding comprises putting a hollow spiral-coil fixing with a wire winding jig into a mold of the molding machine, then implanting the coil at a setting point in a mold cavity, and injecting micron-level soft magnetic metallic powder into the mold cavity, when the quantified metallic metal powder completely wraps the hollow spiral coil, tamping and forming; wherein forming density is not less than 3 g/cm³.

4. The method for preparing the metallic magnetic powder core integrated chip inductor, as recited in claim 1, wherein the primary chamfering comprises mixing molded products in a certain proportion according to the weight of the product and putting the chamfering mediums into the chamfering equipment to complete a chamfering process.

5. The method for preparing the metallic magnetic powder core integrated chip inductor, as recited in claim 1, wherein the hot-press curing comprises placing the products neatly into the cavity of the hot-pressing equipment, wherein a temperature of the hot-pressing equipment cavity is not less than 150° C., and the pressure is not less than 0.5 tons, pressure maintaining for not less than 10 minutes to complete the hot pressing.

6. The method for preparing the metallic magnetic powder core integrated chip inductor, as recited in claim 1, wherein the secondary chamfering comprises mixing the product after thermo-compression and solidification with the chamfering medium in a certain proportion according to the weight of the product and putting into the chamfering equipment to complete a secondary chamfering process.

7. The method for preparing the metallic magnetic powder core integrated chip inductor, as recited in claim 1, wherein the primary nano-insulation coating comprises adopting polyimide nano-materials to conduct insulation coating treatment on a surface of the product; wherein a thickness of the insulation layer is not less than 5 um; after the product is coated, baking at 150° C. for more than 1 hour to cure the insulation layer.

8. The method for preparing the metallic magnetic powder core integrated chip inductor, as recited in claim 1, wherein the primary grinding comprises arranging the products neatly into the jig, performing grinding operations on the products by a high-precision grinder; grinding one side of the products with a length of not less than 5 um and exposing both electrode surfaces of the conductive wire copper interface at both ends of the product and the bottom of the products.

9. The method for preparing the metallic magnetic powder core integrated chip , as recite in claim 1, wherein the electroplating metalized electrode comprises adopting an ion plating technology (PVD technology) or a conventional electroplating process, adding metal and alloy material coating required on a copper-plated surface to increase weldability, soldering resistance and adhesion of the product.

10. The method for preparing the metallic magnetic powder core integrated chip, as recite in claim 1, wherein the step of the testing packaging comprises automatically testing and packaging the products to eliminate products with defective sizes and characteristics, and packaging the products into carrier tapes.
